(19) United States
(12) Patent Application Publication
(10) Pub. No.: US 2026/0152599 A1
(43) Pub. Date: Jun. 4, 2026

(54) POLYURETHANE RESIN COMPOSITION, CARBOXYLIC ACID GROUP-CONTAINING POLYURETHANE (METH)ACRYLATE RESIN, AND METHOD FOR PREPARING AND USE THEREOF

(71) Applicant: SWANCOR INNOVATION & INCUBATION CO., LTD., Nantou City (CN)

(72) Inventor: Jun-Qi KAO, Nantou City (CN)

(21) Appl. No.: 19/458,356

(22) Filed: Jan. 23, 2026

Related U.S. Application Data
(63) Continuation-in-part of application No. PCT/CN2023/121884, filed on Sep. 27, 2023.

(30) Foreign Application Priority Data
Sep. 25, 2023 (CN) 202311239150.3

(51) Int. Cl. C08G 18/67; C08K 3/20; C08K 3/22

(52) U.S. Cl. CPC C08G 18/672; C08K 3/20; C08K 2003/2206; C08K 2003/222; C08K 2003/2224

(57) ABSTRACT

A polyurethane resin composition includes a polyurethane resin containing multiple isocyanate groups, a (meth)acrylate containing a hydroxyl group, and a monohydric alcohol containing a carboxylic acid group. A polyurethane (meth)acrylate resin containing a carboxylic acid group, which is formed by subjecting the aforesaid polyurethane resin composition to a condensation reaction, a method for preparing the aforesaid polyurethane (meth)acrylate resin containing the carboxylic acid group, a curable composition including the aforesaid polyurethane (meth)acrylate resin containing the carboxylic acid group and a polymerizable diluent monomer, and a composite material including a resin component, a fiber and a chemical thickener are also provided.

### CROSS-REFERENCE TO RELATED APPLICATION

This application is a continuation-in-part (CIP) application of International Application No. PCT/CN2023/121884, filed on Sep. 27, 2023, which claims priority to Chinese Patent Application No. 202311239150.3, filed on Sep. 25, 2023. The aforesaid applications are incorporated by reference herein in their entirety.

### FIELD

The disclosure relates to a polyurethane resin composition, and a carboxylic acid group-containing polyurethane (meth)acrylate resin formed from the polyurethane resin composition. The disclosure also relates to a method for preparing and use of the carboxylic acid group-containing polyurethane (meth)acrylate resin.

### BACKGROUND

Composite materials, such as sheet molding compound (SMC) and bulk molding compound (BMC), are widely utilized across various industries due to their favorable properties (e.g., heat resistance and chemical corrosion resistance). They are commonly applied in components of transportation vehicles (e.g., automobiles, ships, and airplanes), sports equipment, construction materials, furniture, etc.

An unsaturated polyester glass fiber-reinforced molding compound is a type of the composite materials that includes an unsaturated polyester resin, a glass fiber, and a chemical thickener (e.g., magnesium oxide, and calcium oxide). Through the interaction between the chemical thickener and the unsaturated polyester resin, the compound undergoes a thickening process, during which a state thereof changes from low viscosity (high fluidity) to high viscosity (no fluidity). When the unsaturated polyester glass fiber-reinforced molding compound is subjected to compression molding at high-temperatures, this interaction between the chemical thickener and the unsaturated polyester resin is eliminated, allowing the unsaturated polyester glass fiber-reinforced molding compound to revert from a non-flowable state back to a highly flowable state, and facilitating manipulation during the molding process. Furthermore, the resulting molded article, due to its improved fluidity, is less prone to defects such as void formation and poor appearance. However, the unsaturated polyester glass fiber-reinforced molding compound exhibits limitations in mechanical properties, particularly in toughness).

To solve the aforesaid problem, a polyurethane (meth)acrylate resin is adopted to replace the unsaturated polyester resin. This polyurethane (meth)acrylate resin is formed by reacting an isocyanate group-containing polyurethane resin with a hydroxyl group-containing (meth)acrylate. Nevertheless, the polyurethane (meth)acrylate resin lacks the ability to react with the chemical thickener, so that a composite material thus formed does not exhibit a thickening effect. Additionally, when the composite material undergoes compression molding under high-temperature pressing conditions, a lack of fluidity thereof may cause the molded article to have a poor appearance, such as the formation of voids.

### SUMMARY

In a first aspect, the present disclosure provides a polyurethane resin composition. The polyurethane resin composition includes a polyurethane resin containing multiple isocyanate groups (—N═C═O), a (meth)acrylate containing a hydroxyl group (—OH), and a monohydric alcohol containing a carboxylic acid group (—COOH). The polyurethane resin containing multiple isocyanate groups is represented by Formula (I),

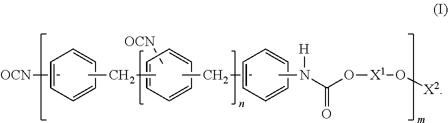

In Formula (I), X¹ is an organic group, and X² is represented by Formula (II),

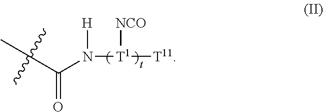

In Formula (II), T¹ is an aromatic group, and T¹¹ is a hydrogen atom or an isocyanate group. Each of m, n, and t is independently a positive number not lower than 1. The organic group is an ethyl group, a propyl group, an allyl group, —C₂H₄—O—C₂H₄—, —C₃H₆—O—C₃H₆—, or —C₄H₈—O—C₄H₈—. The aromatic group is a phenyl group,

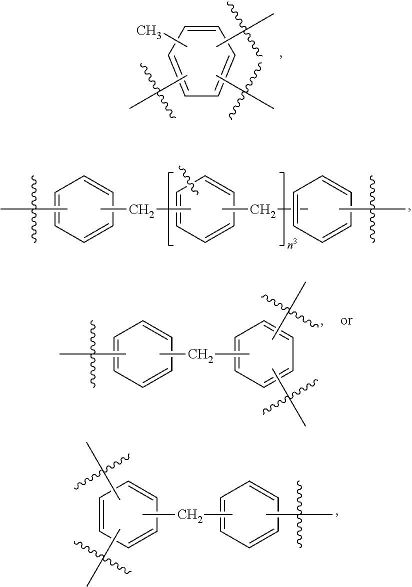

where n¹ is a positive number not lower than 1.

The (meth)acrylate containing the hydroxyl group is selected from the group consisting of hydroxyethyl acrylate, hydroxyethyl methacrylate, hydroxypropyl acrylate, hydroxypropyl methacrylate, and combinations thereof.

The monohydric alcohol containing the carboxylic acid group is selected from the group consisting of 2-Butenedioic acid, 1-(2-hydroxyethyl) ester, 2-Butenedioic acid, mono(2-hydroxypropyl) ester, 2-Butenedioic acid, mono[2-(2-hydroxyethoxy)ethyl]ester, and combinations thereof.

In a second aspect, the present disclosure provides a polyurethane (meth)acrylate resin containing a carboxylic acid group. The polyurethane (meth)acrylate resin containing the carboxylic acid group is represented by Formula (III),

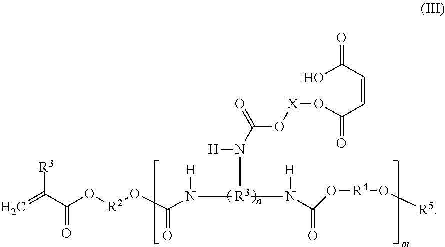

R¹ is a hydrogen atom or a methyl group, R² is an alkyl group, R³ is

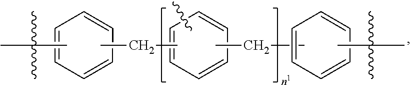

where n¹ is a positive number not lower than 1, R⁴ is an alkyl group, an alkenyl group, or an alkyl ether group, R⁵ is

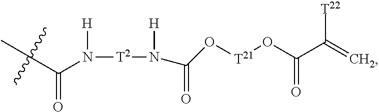

where T² is an organic group, T²¹ is an alkyl group, an alkenyl group, or an alkyl ether group, and T²² is a hydrogen atom or a methyl group, and X is —CH₂—CH₂—, —CH₂—CH₂—O—CH₂—CH₂—, or

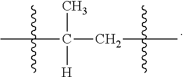 [SMILES: *CC(*)C]

Each of m and n is independently a positive number not lower than 1.

In a third aspect, the present disclosure provides a method for preparing a polyurethane (meth)acrylate resin containing a carboxylic acid group. The method for preparing the polyurethane (meth)acrylate resin containing the carboxylic acid group includes subjecting a hydroxyl group of a monohydric alcohol containing a carboxylic acid group and a hydroxyl group of a (meth)acrylate containing the hydroxyl group to a condensation reaction with multiple isocyanate groups of a polyurethane resin containing multiple isocyanate groups. The monohydric alcohol containing the carboxylic acid group is selected from the group consisting of 2-Butenedioic acid, 1-(2-hydroxyethyl) ester, 2-Butenedioic acid, mono(2-hydroxypropyl) ester, 2-Butenedioic acid, mono[2-(2-hydroxyethoxy)ethyl]ester, and combinations thereof. The (meth)acrylate containing the hydroxyl group is selected from the group consisting of hydroxyethyl acrylate, hydroxyethyl methacrylate, hydroxypropyl acrylate, hydroxypropyl methacrylate, and combinations thereof. The polyurethane resin containing the multiple isocyanate groups is represented by Formula (I),

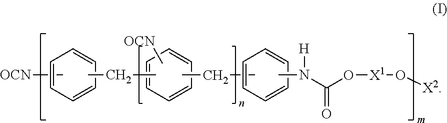

In Formula (I), X¹ is an organic group, and X² is represented by Formula (II),

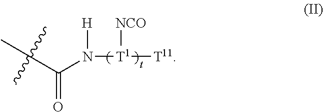

In Formula (II), T¹ is an aromatic group, and T¹¹ is a hydrogen atom or an isocyanate group. Each of m, n, and t is independently a positive number not lower than 1. The organic group is an ethyl group, a propyl group, an allyl group, —C₂H₄—O—C₂H₄—, —C₃H₆—O—C₃H₆—, or —C₄H₈—O—C₄H₈—. The aromatic group is a phenyl group,

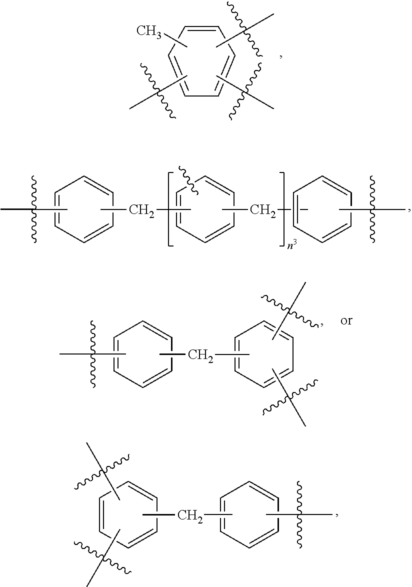

where n¹ is a positive number not lower than 1.

In a fourth aspect, the present disclosure presents a curable composition. The curable composition includes the aforesaid polyurethane (meth)acrylate resin containing the carboxylic acid group, and a polymerizable diluent monomer.

In a fifth aspect, the present disclosure provides a composite material. The composite material includes a resin component, a fiber material, and a chemical thickener. The resin component is the aforesaid polyurethane (meth)acrylate resin containing the carboxylic acid group.

In a sixth aspect, the present disclosure provides a composite material. The composite material includes a resin component, a fiber material, and a chemical thickener. The resin component is the aforesaid curable composition.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

The sole figure is a flow chart illustrating a method for preparing a polyurethane (meth)acrylate resin containing a carboxylic acid group according to the present disclosure.

### DETAILED DESCRIPTION

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

### <Polyurethane Resin Composition>

The present disclosure provides a polyurethane resin composition, which includes a polyurethane resin containing multiple isocyanate groups (—N═C═O), a (meth)acrylate containing a hydroxyl group (—OH), and a monohydric alcohol containing a carboxylic acid group (—COOH). The monohydric alcohol containing the carboxylic acid group is selected from the group consisting of 2-Butenedioic acid, 1-(2-hydroxyethyl) ester

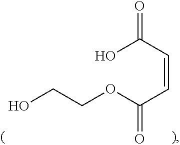 [SMILES: O=C(O)/C=C\C(=O)OCCO]

2-Butenedioic acid, mono[2-(2-hydroxyethoxy)ethyl]ester

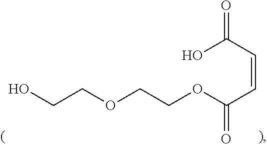 [SMILES: O=C(O)/C=C\C(=O)OCCOCCO]

2-Butenedioic acid, mono(2-hydroxypropyl) ester

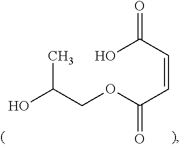

and combinations thereof. The polyurethane resin containing multiple isocyanate groups may be, but is not limited to be, represented by Formula (I),

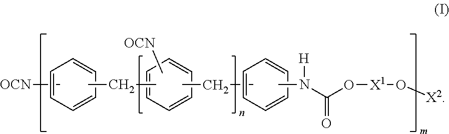

X¹ is an organic group, and X² is represented by Formula (II),

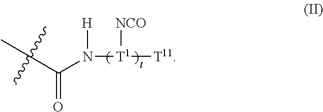

T¹ is an aromatic group, and T¹¹ is a hydrogen atom or an isocyanate group. Each of m, n, and t is independently a positive number not lower than 1. Each of the m and n in Formula (I) and the t in Formula (II) can be adjusted according to a desired ratio of the number of the multiple isocyanate groups of the polyurethane resin containing multiple isocyanate groups to a total number of hydroxyl groups of the (meth)acrylate containing the hydroxyl group and the monohydric alcohol containing the carboxylic acid group. In addition, the organic group is an ethyl group, a propyl group, an allyl group, —C₂H₄—O—C₂H₄—, —C₃H₆—O—C₃H₆—, or —C₄H₈—O—C₄H₈—. The aromatic group may be, but is not limited to, a phenyl group,

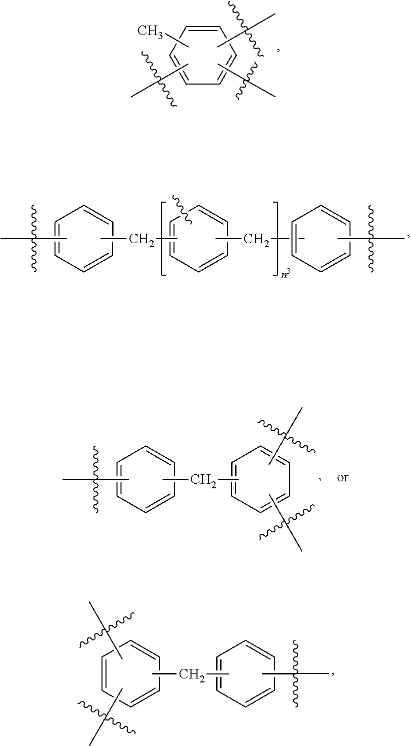

where n¹ is a positive number not lower than 1.

According to the present disclosure, the (meth)acrylate refers to acrylate or methacrylate. The (meth)acrylate containing the hydroxyl group can be used alone or in combination. In addition, the (meth)acrylate containing the hydroxyl group may be, but is not limited to, hydroxyethyl acrylate, hydroxyethyl methacrylate, hydroxypropyl acrylate, or hydroxypropyl methacrylate. In some embodiments, the (meth)acrylate containing the hydroxyl group is selected from the group consisting of hydroxyethyl acrylate, hydroxyethyl methacrylate, hydroxypropyl acrylate, hydroxypropyl methacrylate, and combinations thereof.

In some embodiments, an equivalent ratio of the hydroxyl groups contained in those from the (meth)acrylate containing the hydroxyl group and those from the monohydric alcohol containing the carboxylic acid group to the isocyanate groups of the polyurethane resin containing multiple isocyanate groups may range from 1:1 to 1.05:1.

### <Polyurethane (Meth)Acrylate Resin Containing a Carboxylic Acid Group and Preparation Thereof>

Referring to the figure, a method for preparing a polyurethane (meth)acrylate resin containing a carboxylic acid group may include step S. In step S, the aforesaid polyurethane resin composition is subjected to a condensation reaction, in which a hydroxyl group of the monohydric alcohol containing the carboxylic acid group and the hydroxyl group of the (meth)acrylate containing the hydroxyl group undergo the condensation reaction with the multiple isocyanate groups of the polyurethane resin containing the multiple isocyanate groups, thereby forming the polyurethane (meth)acrylate resin containing the carboxylic acid group. That is to say, the method for preparing the polyurethane (meth)acrylate resin containing the carboxylic acid group includes subjecting the hydroxyl group of the monohydric alcohol containing the carboxylic acid group and the hydroxyl group of the (meth)acrylate containing the hydroxyl group to the condensation reaction with the multiple isocyanate groups of the polyurethane resin containing multiple isocyanate groups.

In some embodiments, in step S, the monohydric alcohol containing the carboxylic acid group and the (meth)acrylate containing the hydroxyl group are mixed, so as to obtain a mixture, and then the mixture is subjected to the condensation reaction with the polyurethane resin containing the multiple isocyanate groups. In still some embodiments, in step S, the (meth)acrylate containing the hydroxyl group is subjected to a first reaction with the polyurethane resin containing multiple isocyanate groups, so as to obtain a reaction mixture, and then the monohydric alcohol containing the carboxylic acid group is subjected to a second reaction with the reaction mixture.

Referring to the figure, in some embodiments, the method for preparing the polyurethane (meth)acrylate resin containing the carboxylic acid group may further include step Q.

In step Q, the polyurethane resin containing multiple isocyanate groups is obtained by subjecting a reaction component containing a polyol material and a polyisocyanate material to a polycondensation reaction. The polyisocyanate material may be an isocyanate compound containing two or more isocyanate groups, and the polyol material may be a polyol compound containing two or more hydroxyl groups.

In some embodiments, in order to ensure that the polyurethane resin containing multiple isocyanate groups has appropriate rigidity, an equivalent ratio of isocyanate groups of the polyisocyanate material to hydroxyl groups of the polyol material may range from 1.5:1 to 10:1. In still some embodiments, in order to ensure that the polyurethane resin containing multiple isocyanate groups has appropriate rigidity, the polyol material is a polyol having a number average molecular weight of less than 2000. The polyol having the number average molecular weight of less than 2000 may include, but is not limited to, polypropylene glycol, polyoxyethylene ether, polyoxypropylene ether, or polytetrahydrofuran. The polyisocyanate material may be, but is not limited to, an aromatic polyisocyanate. The aromatic polyisocyanate may include, but is not limited to, toluene diisocyanate, polymethylene diphenyl diisocyanate, or diphenylmethane diisocyanate. In some embodiments, the polyisocyanate material may be selected from the group consisting of toluene diisocyanate, polymethylene diphenyl diisocyanate, or diphenylmethane diisocyanate. The polyisocyanate material may be, but is not limited to, a product with model number MR200 purchased from Tosoh Corporation, a product with model number PM200 purchased from Wanhua Chemical Group Co., Ltd., a product with model number M20S purchased from Badische Anilin-und-Soda-Fabrik Co., Ltd. (BASF), a product with model number 44V20 purchased from Covestro Co., Ltd., a product with model number 5005 purchased from Huntsman Corporation, a product with model number NM purchased from Tosoh Corporation, or a product with model number MDI-50 purchased from Wanhua Chemical Group Co., Ltd.

In some embodiments, the reaction component may further include a catalyst. Examples of the catalyst may include, but are not limited to, an organotin catalyst, an organobismuth catalyst, or an organozinc catalyst. An example of the organotin catalyst may include, but is not limited to, dibutyltin dilaurate. In some embodiments, based on 1 kg of the polyurethane (meth)acrylate resin containing the carboxylic acid group, an amount of the catalyst may range from 50 mg to 200 mg.

In other embodiments, the reaction component may further contain an inhibitor. The inhibitor may be an inhibitor currently used in a free radical curing system resin, such as 2,5-dihydroxytoluene, and will not be described in detail.

In some embodiments, the reaction component may further contain a diluent monomer. Examples of the diluent monomer may include, but are not limited to, methyl acrylate, methyl methacrylate, ethyl acrylate, ethyl methacrylate, hydroxyethyl acrylate, hydroxyethyl methacrylate, hydroxypropyl acrylate, hydroxypropyl methacrylate, isobornyl acrylate, isobornyl methacrylate, cyclohexyl acrylate, cyclohexyl methacrylate, tetrahydrofurfuryl acrylate, tetrahydrofurfuryl methacrylate, styrene, methylstyrene, or vinyltoluene.

In more details, the polyisocyanate material, the catalyst, the inhibitor and the diluent monomer are mixed, so as to obtain a mixture, and subsequently, the mixture is mixed with the polyol material, thereby obtaining the reaction component.

Referring to the figure, in some embodiments, the method for preparing the polyurethane (meth)acrylate resin containing the carboxylic acid group may further include step R. In step R, the monohydric alcohol containing the carboxylic acid group is obtained by subjecting a diol to a reaction with a maleic anhydride. The diol is selected from the group consisting of ethylene glycol, diethylene glycol, and glycerol. In the reaction, temperature is raised in stages.

In more details, during a first stage of the reaction, the diol and the maleic anhydride are reacted at a first temperature, and then the first temperature is raised to a second temperature, followed by a second stage of the reaction carried out at the second temperature. In some embodiments, the first temperature may range from 50° C. to 70° C. In still some embodiments, the first temperature may range from 55° C. to 65° C. In some embodiments, the second temperature may range from 70° C. to 90° C. In still some embodiments, the second temperature may range from 75° C. to 85° C.

In some embodiments, the polyurethane (meth)acrylate resin containing the carboxylic acid group may be represented by Formula (III),

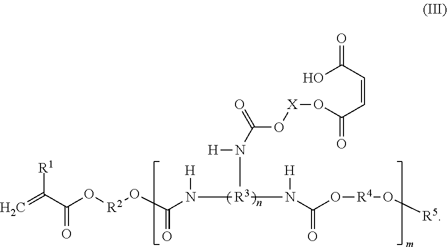

In Formula (III), R¹ is a hydrogen atom or a methyl group, R² is an organic group, R³ is an organic group, R⁴ is an organic group, R⁵ is

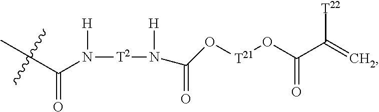

and X is —CH₂—CH₂—, —CH₂—CH₂—O—CH₂—CH₂—, or

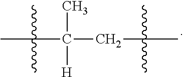 [SMILES: *CC(*)C]

In R⁵, T² is an organic group containing an isocyanate group or an organic group not containing an isocyanate group, T²¹ is an organic group, and T²² is a hydrogen atom or a methyl group. Each of m and n is independently a positive number not lower than 1.

In order to enable the polyurethane (meth)acrylate resin containing the carboxylic acid group to have an appropriate acid value, so as to have a better thickening effect and allow a composite material that is formed from the polyurethane (meth)acrylate resin containing the carboxylic acid group to have a lower water absorbency, in some embodiments, m/n may range from 1.8 to 3. An example of R² (the organic group) may be an alkyl group. Examples of the alkyl group may be an ethyl group and a propyl group.

R³ (the organic group) contains an aromatic group. Examples of R³ containing the aromatic group may be a phenyl group,

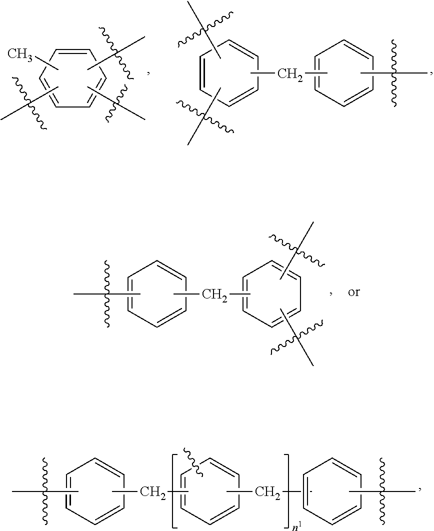

where n¹ is a positive number not lower than 1.

Examples of the organic group having the isocyanate group (T²) may be a phenyl group containing an isocyanate group,

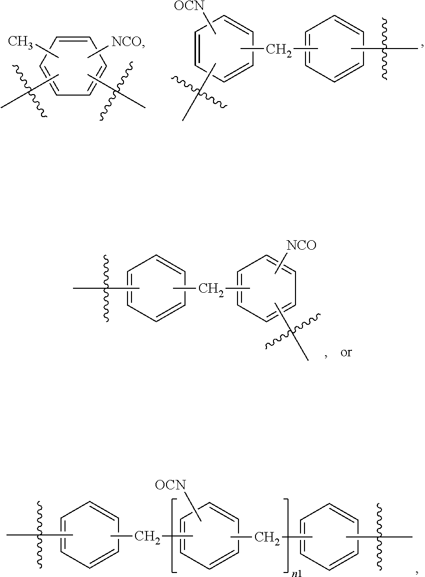

where n¹ is a positive number not lower than 1. Examples of the organic group not containing the isocyanate group (T²) may be a phenyl group,

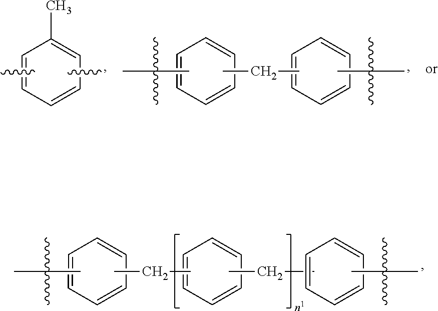

where n¹ is a positive number not lower than 1.

For each of R⁴ in Formula (III) and T²¹ in R⁵, examples of the alkyl group may be an ethyl group and a propyl group, an example of the alkenyl group may be an allyl group, and examples of the alkyl ether group may be, but are not limited to, —C₂H₄—O—C₂H₄—, —C₃H₆—O—C₃H₆—, or —C₄H₈—O—C₄H₈—.

In some embodiments, in order to accelerate a reaction between the polyurethane (meth)acrylate resin containing the carboxylic acid group and a chemical thickener and to reduce water absorption of the composite material, an acid value of the polyurethane (meth)acrylate resin containing the carboxylic acid group may range from 10 mgKOH/g to 40 mgKOH/g. In still some embodiments, the acid value of the polyurethane (meth)acrylate resin containing the carboxylic acid group may range from 15 mgKOH/g to 30 mgKOH/g.

### <Curable Composition>

The present disclosure also provides a curable composition, which includes the aforesaid polyurethane (meth)acrylate resin containing the carboxylic acid group and a polymerizable diluent monomer.

According to the present disclosure, the polymerizable diluent monomer serves as a viscosity adjuster to impart an appropriate viscosity to the curable composition, thereby providing the curable composition with a suitable fluidity and enabling the curable composition to cope with conditions required for subsequent operations. Examples of the polymerization diluent monomer may include, but are not limited to, methyl acrylate, methyl methacrylate, ethyl acrylate, ethyl methacrylate, hydroxyethyl acrylate, hydroxyethyl methacrylate, hydroxypropyl acrylate, hydroxypropyl methacrylate, isobornyl acrylate, isobornyl methacrylate, cyclohexyl acrylate, cyclohexyl methacrylate, tetrahydrofurfuryl acrylate, tetrahydrofurfuryl methacrylate, styrene, methylstyrene, or vinyltoluene. In some embodiments, the polymerizable diluent monomer may be selected from the group consisting of methyl acrylate, methyl methacrylate, ethyl acrylate, ethyl methacrylate, hydroxyethyl acrylate, hydroxyethyl methacrylate, hydroxypropyl acrylate, hydroxypropyl methacrylate, isobornyl acrylate, isobornyl methacrylate, cyclohexyl acrylate, cyclohexyl methacrylate, tetrahydrofurfuryl acrylate, tetrahydrofurfuryl methacrylate, styrene, methylstyrene, vinyltoluene, and combinations thereof.

### <Composite Material>

The present disclosure further provides a composite material, which includes a resin component, a fiber material, and a chemical thickener. The resin component is selected from the aforesaid polyurethane (meth)acrylate resin containing the carboxylic acid group or the aforesaid curable composition.

In some embodiments, based on a total amount of the resin component as 100 parts by weight, the fiber material may be present in an amount ranging from 67 parts by weight to 135 parts by weight. Examples of the fiber material may be, but are not limited to, a glass fiber, a carbon fiber, or a polyamide fiber. In some embodiments, the fiber material may be selected from the glass fiber, the carbon fiber, and the polyamide fiber.

In some embodiments, based on a total amount of the resin component as 100 parts by weight, the chemical thickener may be present in an amount ranging from 1 part by weight to 1.5 parts by weight. Examples of the chemical thickener may be, but are not limited to, an alkaline earth metal oxide or an alkaline earth metal hydroxide. In some embodiments, the chemical thickener may be selected from the group consisting of the alkaline earth metal oxide, the alkaline earth metal hydroxide, and a combination thereof. Examples of the alkaline earth metal oxide may be, but are not limited to, magnesium oxide or calcium oxide. Examples of the alkaline earth metal hydroxide may be, but are limited to, magnesium hydroxide or calcium hydroxide.

In some embodiments, the composite material may further include an inorganic filler. Examples of the inorganic filler may be, but are not limited to, titanium dioxide, silicon dioxide, calcium carbonate, aluminum oxide, aluminum hydroxide, or silicon carbide.

In some embodiments, the composite material may further include an additive. Examples of the additive may include, but are not limited to, a flame retardant, an inhibitor, a mold release agent, a hardener, a viscosity adjuster, a wetting and dispersing agent, or a low-shrinkage additive. In some embodiments, based on a total amount of the resin component as 100 parts by weight, the flame retardant may be present in an amount ranging from 220 parts by weight to 300 parts by weight. An example of the flame retardant may be, but is not limited to, aluminum hydroxide. In some embodiments, based on a total amount of the resin component as 100 parts by weight, the inhibitor may be present in an amount ranging from 0.01 parts by weight to 0.03 parts by weight. An example of the inhibitor may be, but is not limited to, 2,6-di-tert-butyl-4-methylphenol. In some embodiments, based on a total amount of the resin component as 100 parts by weight, the mold release agent may be present in an amount ranging from 3 parts by weight to 5 parts by weight. An example of the mold release agent may be, but is not limited to, zinc stearate. In some embodiments, based on a total amount of the resin component as 100 parts by weight, the hardener may be present in an amount ranging from 3 parts by weight to 4 parts by weight. An example of the hardener may be, but is not limited to, tert-butyl peroxybenzoate. In some embodiments, based on a total amount of the resin component as 100 parts by weight, the viscosity adjuster may be present in an amount ranging from 30 parts by weight to 40 parts by weight. An example of the viscosity adjuster may be, but is not limited to, a diluent monomer. An example of the diluent monomer may be, but is not limited to, styrene. In some embodiments, based on a total amount of the resin component as 100 parts by weight, the wetting and dispersing agent may be present in an amount ranging from 2 parts by weight to 3 parts by weight. An example of the wetting and dispersing agent may be, but is not limited to, a commercial product which has model number BYK-W 996 and is manufactured by BYK Additives & Instruments. In some embodiments, based on a total amount of the resin component as 100 parts by weight, the low-shrinkage additive may be present in an amount ranging from 13 parts by weight to 28 parts by weight. An example of the low-shrinkage additive may be, but is not limited to, vinyl acetate.

The composite material can be used in parts of transportation vehicles (e.g., automobiles, ships, airplanes, etc.), sports equipment, construction materials, home furnishings, and so forth.

The disclosure will be further described by way of the following examples. However, it should be understood that the following examples are solely intended for the purpose of illustration and should not be construed as limiting the disclosure in practice.

### <Synthesis Example 1>2-Butenedioic acid, 1-(2-hydroxyethyl) ester

391.3 g of ethylene glycol and 562.0 g of maleic anhydride were placed into a reaction kettle, so as to form a mixture. A molar ratio of the ethylene glycol to the maleic anhydride was 1.10. After that, the mixture was heated to 55° C., so as to subject the mixture to a first stage of a reaction at 55° C. for 60 minutes, followed by raising the temperature to 70° C., so as to subject the mixture to a second stage of the reaction at 70° C. for 300 minutes, thereby obtaining 2-Butenedioic acid, 1-(2-hydroxyethyl) ester.

### <Synthesis Example 2>2-Butenedioic acid, mono[2-(2-hydroxyethoxy)ethyl]ester

116.7 g of diethylene glycol and 98.1 g of maleic anhydride were placed into a reaction kettle, so as to form a mixture. A molar ratio of the diethylene glycol to the maleic anhydride was 1.10. After that, the mixture was heated to 55° C., so as to subject the mixture to a first stage of a reaction at 55° C. for 60 minutes, followed by raising the temperature to 80° C., so as to subject the mixture to a second stage of the reaction at 80° C. for 300 minutes, thereby obtaining 2-Butenedioic acid, mono[2-(2-hydroxyethoxy)ethyl]ester.

### <Synthesis Example 3>2-Butenedioic acid, mono(2-hydroxypropyl) ester

443.9 g of propylene glycol and 520.0 g of maleic anhydride were placed into a reaction kettle, so as to form a mixture. A molar ratio of the propylene glycol to the maleic anhydride was 1.10 in decimal form. After that, the mixture was heated to 55° C., so as to subject the mixture to a first stage of a reaction at 55° C. for 60 minutes, followed by raising the temperature to 80° C., so as to subject the mixture to a second stage of the reaction at 80° C. for 300 minutes, thereby obtaining 2-Butenedioic acid, mono(2-hydroxypropyl) ester.

### <Example 1 (E1)> Polyurethane (Meth)acrylate Resin Containing Carboxylic Acid Group(s) and Curable Composition

640.0 g of poly[methylene(polyphenyl) isocyanate](pMDI) (Tosoh Corporation; Model number: MR200; Content of isocyanate groups: 31.25%±0.75%; Equivalent of the isocyanate groups: 4.76), 0.82 g of 2,5-dihydroxytoluene (serving as an inhibitor), and 0.308 g of dibutyltin dilaurate (serving as a catalyst) were dispersed in 412 g of methyl methacrylate (serving as a diluent monomer), followed by mixing thoroughly and then heating to a temperature of 50° C.±2° C., thereby obtaining a first mixture.

Thereafter, 317.5 g of polypropylene glycol (Oriental Union Chemical Corporation; Model number: PPG400; Average molecular weight: 400; Equivalent of the hydroxyl groups: 1.59) was slowly added to the first mixture in a dropwise manner for a time period of 50 minutes±10 minutes and at a temperature controlled at 54° C.±6° C., and an equivalent ratio of isocyanate groups in the poly[methylene(polyphenyl) isocyanate] to hydroxyl groups in the polypropylene glycol was maintaining a 3:1 ratio, so as to obtain a first intermediate mixture. Subsequently, the first intermediate mixture was maintained at 50° C.±2° C. for 2.5 hours±0.5 hours, thereby obtaining a second mixture that contained a polyurethane resin containing multiple isocyanate groups.

Next, a third mixture was slowly added to the second mixture in a dropwise manner for a time period of 50 minutes±10 minutes and at a temperature controlled at 50° C.±5° C., so as to obtain a second intermediate mixture. The third mixture contained 340.8 g of hydroxyethyl methacrylate and 127.1 g of 2-Butenedioic acid, 1-(2-hydroxyethyl) ester of Synthesis Example 1. In addition, an equivalent ratio of hydroxyl groups of the third mixture to isocyanate groups of the polyurethane resin containing multiple isocyanate groups was 1.05. Subsequently, the second intermediate mixture was maintained at 50° C.±2° C. for a time period of 2.5 hours±0.5 hours. In addition, during the time period, the content of the isocyanate groups was measured, and when the content of the isocyanate groups reached 0.67%, 206 g of methyl methacrylate (serving as a polymerizable diluent monomer) was added thereto, thereby obtaining a curable composition. The curable composition included a polyurethane methacrylate resin containing carboxylic acid group(s) and the methyl methacrylate. Additionally, the curable composition had a viscosity of 1600 cps, and an acid value of 21 mgKOH/g.

### <Example 2 (E2)> Polyurethane (Meth)acrylate Resin Containing Carboxylic Acid Group(s) and Curable Composition

150.0 g of poly[methylene(polyphenyl) isocyanate](Wanhua Chemical Group Co., Ltd.; Model number: PM200; Content of isocyanate groups: 31.25%±0.75%; Equivalent of the isocyanate groups: 1.12), 0.21 g of 2,5-dihydroxytoluene (serving as an inhibitor), and 0.08 g of dibutyltin dilaurate (serving as a catalyst) were dispersed in 90.0 g of methyl methacrylate (serving as a diluent monomer), followed by mixing thoroughly and then heating to a temperature of 50° C.±2° C., thereby obtaining a first mixture.

Thereafter, 74.4 g of polypropylene glycol (Oriental Union Chemical Corporation; Model number: PPG400; Average molecular weight: 400; Equivalent of hydroxyl groups: 0.37) was slowly added to the first mixture in a dropwise manner for a time period of 50 minutes±10 minutes and at a temperature controlled at 54° C.±6° C., and an equivalent ratio of the isocyanate groups of in the poly[methylene(polyphenyl) isocyanate] to the hydroxyl groups of in the polypropylene glycol was maintaining a 3:1 ratio, so as to obtain a first intermediate mixture. Subsequently, the first intermediate mixture was maintained at 50° C.±2° C. for 2.5 hours±0.5 hours, thereby obtaining a second mixture that contained a polyurethane resin containing multiple isocyanate groups.

Next, a third mixture was slowly added to the second mixture in a dropwise manner for a time period of 50 minutes±10 minutes and at a temperature controlled to be below 50° C.±5° C., so as to obtain a second intermediate mixture. The third mixture contained 72.6 g of hydroxyethyl methacrylate and 38.0 g of 2-Butenedioic acid, mono[2-(2-hydroxyethoxy)ethyl]ester of Synthesis Example 2. In addition, an equivalent ratio of hydroxyl groups of the third mixture to isocyanate groups of the polyurethane resin containing multiple isocyanate groups was 1.03. Subsequently, the second intermediate mixture was maintained at 50° C.±2° C. for a time period of 2.5 hours±0.5 hours. In addition, during the time period, the content of the isocyanate groups was measured, and when the content of the isocyanate groups reached 0.48%, 90.0 g of methyl methacrylate (serving as a polymerizable diluent monomer) was added thereto, thereby obtaining a curable composition. The curable composition included a polyurethane methacrylate resin containing carboxylic acid group(s) and the methyl methacrylate. Additionally, the curable composition had a viscosity of 2600 cps, and an acid value of 20 mgKOH/g.

### <Example 3 (E3)> Polyurethane (Meth)acrylate Resin Containing Carboxylic Acid Group(s) and Curable Composition

640.0 g of poly[methylene(polyphenyl) isocyanate](Wanhua Chemical Group Co., Ltd.; Model number: PM200; Content of isocyanate groups: 31.25%±0.75%; Equivalent of the isocyanate groups: 4.76), 0.83 g of 2,5-dihydroxytoluene (serving as an inhibitor), and 0.308 g of dibutyltin dilaurate (serving as a catalyst) were dispersed in 412.0 g of methyl methacrylate (serving as a diluent monomer), followed by mixing thoroughly and then heating to a temperature of 50° C.±2° C., thereby obtaining a first mixture.

Thereafter, 317.5 g of polypropylene glycol (Oriental Union Chemical Corporation; Model number: PPG400; Average molecular weight: 400; Equivalent of the hydroxyl groups: 1.59) was slowly added to the first mixture in a dropwise manner for a time period of 50 minutes±10 minutes and at a temperature controlled at 54° C.±6° C., and an equivalent ratio of the isocyanate groups of in the poly[methylene(polyphenyl) isocyanate] to the hydroxyl groups of in the polypropylene glycol was maintaining a 3:1 ratio, so as to obtain a first intermediate mixture. Subsequently, the first intermediate mixture was maintained at 50° C.±2° C. for 2.5 hours±0.5 hours, thereby obtaining a second mixture that contained a polyurethane resin containing multiple isocyanate groups.

Next, a third mixture was slowly added to the second mixture in a dropwise manner for a time period of 50 minutes±10 minutes and at a temperature controlled below 50° C.±5° C., so as to obtain a second intermediate mixture. The third mixture contained 340.8 g of hydroxyethyl methacrylate and 138.2 g of 2-Butenedioic acid, mono(2-hydroxypropyl) ester of Synthesis Example 3. In addition, an equivalent ratio of hydroxyl groups of the third mixture to isocyanate groups of the polyurethane resin containing multiple isocyanate groups was 1.02. Subsequently, the second intermediate mixture was maintained at 50° C.±2° C. for a time period of 2.5 hours±0.5 hours. In addition, during the time period, the content of the isocyanate groups was measured, and when the content of the isocyanate groups reached 0.23%, 206.0 g of methyl methacrylate (serving as a polymerizable diluent monomer) was added thereto, thereby obtaining a curable composition. The curable composition included a polyurethane methacrylate resin containing carboxylic acid group(s) and the methyl methacrylate. Additionally, the curable composition had a viscosity of 1900 cps, and an acid value of 22 mgKOH/g.

### Property Evaluation

Measurement of Viscosity (Unit: cps):

The curable composition of each of E1 to E3 was subjected to measurement of viscosity by placing in a viscosity measuring instrument (Brookfield Engineering Laboratories, Inc.; Model: DV-I Prime; including a viscometer, a thermostatic water bath circulator, and an S14 spindle) at a temperature controlled at 25° C. using such thermostatic water bath circulator, and at a rotational speed of 100 rpm.

Measurement of Acid Value (unit: mgKOH/q):

0.6 g±0.1 g of each of the aforesaid polyurethane (meth)acrylate resin containing carboxylic acid group(s) and curable compositions (E1 to E3) was subjected to measurement of acid value by dissolving the same in 10 mL of a solvent mixture (including toluene and isopropanol at a weight ratio of 1:1), followed by addition of a phenolphthalein indicator and titration with 0.1 N ethanolic potassium hydroxide solution.

Measurement of Isocyanate Group Content (unit: %):

0.25 g±0.05 g of the polyurethane resin containing multiple isocyanate groups used in each of E1 to E3 and the polyurethane methacrylate resin containing carboxylic acid groups used in each of E1 to E3 was subjected to measurement of isocyanate group content by dissolving the same in 15 mL of a component (including dibutylamine and toluene, where the dibutylamine had a concentration of 0.1 N), followed by stirring for 10 minutes, addition of a bromophenol blue indicator, and titration with 0.1 N aqueous hydrochloric acid solution to an end point.

### Measurement of Thickening Property:

100 parts by weight of the curable composition of each of E1 to E3 was subjected to measurement of thickening property by mixing the same with 1 part by weight of magnesium oxide (serving as a chemical thickener) in a high-shear disperser, and then shearing at 1000 rpm for 10 minutes, followed by leaving to stand at 23° C.±1° C. for a storage period of 13 days. Four different portions of each of the resultant mixtures were subjected to measurement of viscosity using a viscosity measuring instrument (Brookfield Engineering Laboratories, Inc.; Model: DV-I Prime) on the 0^{th} day, the 3^{rd} day, the 6^{th} day, and the 13^{th} day, respectively. The results were shown in Table 1 below.

TABLE 1

| | | E1 | E2 | E3 |
|---|---|---|---|---|
| Curable composition | | 100 | 100 | 100 |
| (part(s) by weight) | | | | |
| Magnesium oxide | | 1 | 1 | 1 |
| (part(s) by weight) | | | | |
| Viscosity at | 0^{th} day | 1825 | 2900 | 2225 |
| 25° C. (cps) | 3^{rd} day | 6900 | 10250 | 8100 |
| | 6^{th} day | 15700 | 22500 | 19813 |
| | 13^{th} day | 58750 | 70750 | 68750 |

Referring to Table 1, the viscosity of the curable composition of each of E1 to E3 increased with length of the storage period, indicating that the polyurethane methacrylate resin containing carboxylic acid groups of the present disclosure can indeed interact with the chemical thickener (i.e., the magnesium oxide), thereby increasing viscosity and exhibiting a thickening effect.

### Charpy Impact Strength Test:

The curable composition of each of E1 to E3 was uniformly mixed with 0.015 wt %±0.005 wt % of cobalt isooctanoate and 1.5 wt %±0.5 wt % of methyl ethyl ketone peroxide (1% to 2%), followed by defoaming treatment, so as to obtain a mixture. The mixture was then poured into a glass mold with a thickness of 4 mm, then allowed to cure at room temperature for 24 hours, and subsequently, baked at 105° C. for 2 hours, so as to obtain a cured cast plate. The cured cast plate was cut into a specimen having a dimension of 80 mm×10 mm×4 mm, which was then subjected to an unnotched impact strength test for plastics in accordance with the International Organization for Standardization (ISO) 179 standard using an impact tester (Cometech Testing Machines Co., Ltd.; Model: QC-639), so as to determine Charpy impact strength thereof. For comparison purpose, an unsaturated polyester resin (REICHHOLD; Model: POLYLITE 413-000) was also subjected to the Charpy impact strength test using procedures generally similar to those for determining the Charpy impact strength of the curable composition of each of E1 to E3 (except that the curable composition of each of E1 to E3 was replaced with the unsaturated polyester resin), so as to determine Charpy impact strength thereof. The results were shown in Table 2 below.

TABLE 2

| | Unsaturated | | | |
|---|---|---|---|---|
| | polyester resin | E1 | E2 | E3 |
| Charpy impact | 7.5 ± 2.5 | 24 | 22 | 25 |
| strength (KJ/m²) | | | | |

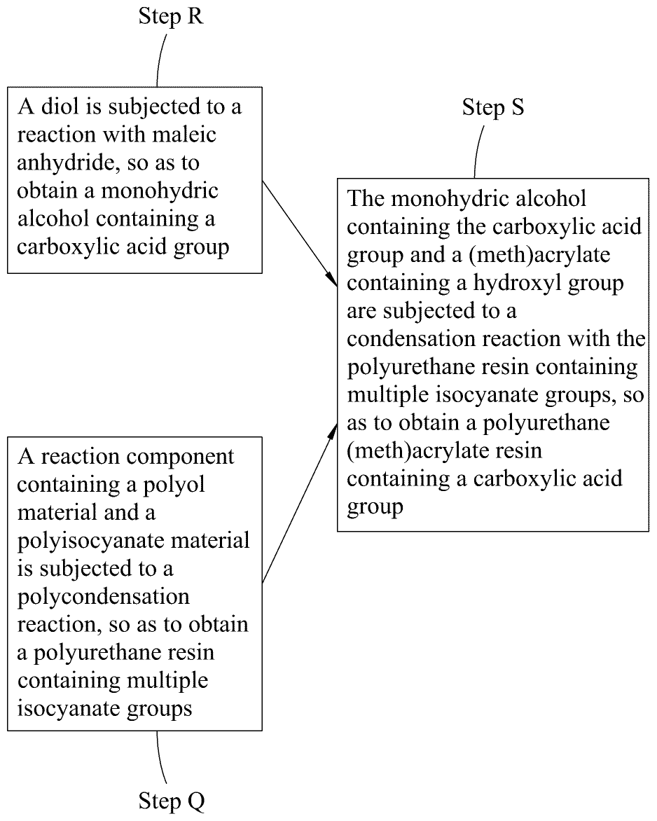

Referring to FIG. 2, the Charpy impact strength of the specimen formed from the curable composition obtained in each of E1 to E3 was significantly higher than that of the specimen formed from the unsaturated polyester resin, indicating that the polyurethane methacrylate resin containing carboxylic acid groups of the present disclosure indeed shows better enhancement of toughness.

### <Application Example 1 (AE1)> Composite Material and Molded Article Made Therefrom

100 parts by weight of the curable composition of E1, 38 parts by weight of styrene (serving as a viscosity adjuster), 28 parts by weight of vinyl acetate (serving as a low-shrinkage additive), 0.03 parts by weight of 2,6-di-tert-butyl-4-methylphenol (serving as an inhibitor), 3 parts by weight of a copolymer solution containing acid-functional groups (serving as a wetting and dispersing agent; BYK Additives & Instruments; Model: BYK-W 996) (hereinafter abbreviated as “BYK-W 996”), 3 parts by weight of tert-butyl peroxybenzoate (serving as a hardener), and 1.5 parts by weight of magnesium oxide (serving as a chemical thickener) were placed in a high-shear disperser and stirred for 5 minutes, followed by adding 300 parts by weight of aluminum hydroxide (serving as a flame retardant), which was added incrementally in several equal portions, and subsequently, mixing was conducted at 1000 rpm for 10 minutes, thereby obtaining a mixture. After that, the mixture, 3 parts by weight of zinc stearate (serving as a mold release agent), and 108 parts by weight of a carbon fiber (having a length of 1 cm) were introduced into a twin-screw kneader, so as to obtain a halogen-free flame-retardant lumped composite material. The halogen-free flame-retardant lumped composite material was then introduced into a mold of a compression molding machine and subjected to compression molding at a pressure of 50 kg/cm² and a temperature of 150° C., thereby obtaining a molded article.

### <Application Examples 2 and 3 (AE2 and AE3)> Composite Material and Molded Article Made Therefrom

The procedures for preparing the halogen-free flame-retardant lumped composite material in each of AE2 and AE3 was generally similar to those of AE1, except that the type and amount of ingredients were varied as shown in Table 3 below. Similarly, the molded article of each of AE2 (formed from the halogen-free flame-retardant lumped composite material of AE2) and AE3 (formed from the halogen-free flame-retardant lumped composite material of AE3) was obtained using procedures generally similar to the procedures for preparing the molded article of AE described above.

TABLE 3

| | | AE1 | AE2 | AE3 |
|---|---|---|---|---|
| Curable | E1 | 100 | 0 | 0 |
| composition | E2 | 0 | 100 | 0 |
| | E3 | 0 | 0 | 100 |

| | | | |
|---|---|---|---|
| Styrene | 38 | 30 | 35 |
| Vinyl acetate | 28 | 25 | 13 |
| BYK-W 996 | 3 | 2.8 | 2.7 |
| Tert-butyl | 3 | 3 | 3 |
| peroxybenzoate | | | |
| 2,6-di-tert-butyl- | 0.03 | 0.02 | 0.01 |
| 4-methylphenol | | | |
| Magnesium oxide | 1.5 | 1 | 1.3 |
| Aluminum hydroxide | 300 | 240 | 220 |
| Zinc stearate | 3 | 3 | 3 |
| Carbon fiber | 108 | 135 | 67 |

### Property Evaluation

Measurement of Average Flexural Strength (unit: MPa):

The molded article of each of AE1 to AE3 was cut into five specimens, each having a dimension of 100 mm×15 mm×3 mm. Each of the five specimens was then subjected to measurement of flexural strength in accordance with ISO 14125 standard using a universal tensile testing machine (Instron; Model: 5892), so as to calculate the average flexural strength thereof. The results were shown in Table 4 below.

### Measurement of Flame Retardancy:

The molded article of each of AE1 to AE3 was cut into five specimens, each having a dimension of 127 mm×12.7 mm×3 mm. Each of the five specimens was then subjected to measurement of flame retardancy using a vertical burning test. Specifically, each specimen was exposed to a flame for a first time period of 10 seconds, and then removed from the flame, followed by measurement of a first afterflame time. Subsequently, the specimen was exposed to the flame again for a second time period of 10 seconds, followed by measurement of a second afterflame time after removal from the flame. The first and second afterflame times were summed to obtain a total afterflame time, and when the total afterflame time was less than 10 seconds, the specimen was classified as V-0 according to the Underwriters Laboratories (UL) 94 standard. The results were shown in Table 4 below.

TABLE 4

| | AE1 | AE2 | AE3 |
|---|---|---|---|
| Average flexural | 92 | 102 | 98 |
| strength (MPa) | | | |
| Flame retardancy | V-0 | V-0 | V-0 |

Referring to Table 4, the molded article of each of AE1 to AE3 had good flexural strength that meets industry requirements, indicating that the ingredients in the composite material (i.e., the halogen-free flame-retardant lumped composite material) could indeed be mixed evenly, which results in good properties of the molded article.

In summary, the polyurethane (meth)acrylate resin containing the carboxylic acid group of the present disclosure is able to interact with the chemical thickener, so that state thereof can be changed from having a low viscosity (high fluidity) to having a high viscosity (non-fluidity), and that a thickening phenomenon occurs. In addition, when the composite material including the polyurethane (meth)acrylate resin containing the carboxylic acid group is subjected to compression molding under high-temperature pressing conditions, state thereof can be converted from non-fluidity to high-fluidity, and hence the composite material can be manipulated during the compression molding. Moreover, the ingredients in the composite material, due to fluidity thereof, can be mixed evenly, resulting in good quality of the molded article (e.g., without formation of void), thus achieving the purpose of the present disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A polyurethane resin composition, comprising:
a polyurethane resin containing multiple isocyanate groups, a (meth)acrylate containing a hydroxyl group, and a monohydric alcohol containing a carboxylic acid group, the polyurethane resin containing the multiple isocyanate groups being represented by Formula (I), 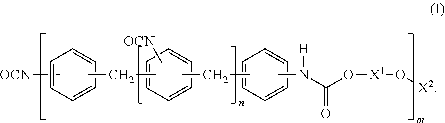
wherein
X¹ is an organic group;
X² is represented by Formula (II); 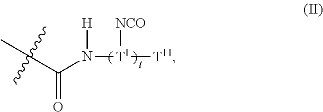
where T¹ is an aromatic group, T¹¹ is a hydrogen atom or —NCO, and each of m, n, and t is independently an integer not lower than 1, and
wherein
the organic group is an ethyl group, a propyl group, an allyl group, —C₂H₄—O—C₂H₄—, —C₃H₆—O—C₃H₆—, or —C₄H₈—O—C₄H₈—; and
the aromatic group is a phenyl group, 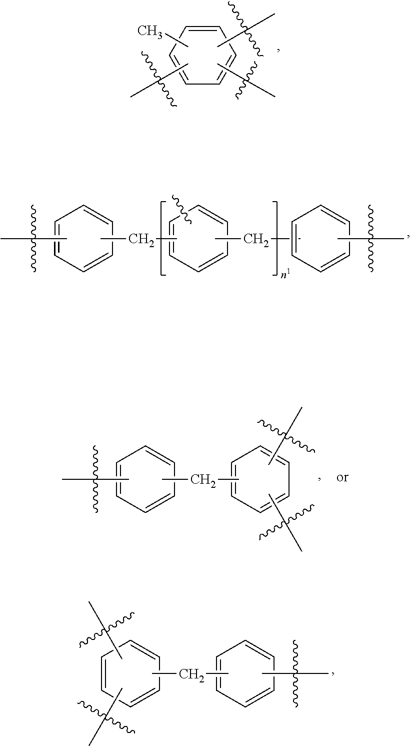
where n¹ is a positive number not lower than 1,
the (meth)acrylate containing the hydroxyl group being selected from the group consisting of hydroxyethyl acrylate, hydroxyethyl methacrylate, hydroxypropyl acrylate, hydroxypropyl methacrylate, and combinations thereof,
the monohydric alcohol containing the carboxylic acid group being selected from the group consisting of 2-Butenedioic acid, 1-(2-hydroxyethyl) ester, 2-Butenedioic acid, mono(2-hydroxypropyl) ester, 2-Butenedioic acid, mono[2-(2-hydroxyethoxy)ethyl]ester, and combinations thereof.

2. A polyurethane (meth)acrylate resin containing a carboxylic acid group, which is formed by subjecting the polyurethane resin composition as claimed in claim 1 to a condensation reaction, in which a hydroxyl group of the monohydric alcohol containing the carboxylic acid group and the hydroxyl group of the (meth)acrylate containing the hydroxyl group undergo the condensation reaction with the multiple isocyanate groups of the polyurethane resin containing multiple isocyanate groups.

3. The polyurethane (meth)acrylate resin containing the carboxylic acid group as claimed in claim 2, which has an acid value ranging from 10 mgKOH/g to 40 mgKOH/g.

4. A polyurethane (meth)acrylate resin containing a carboxylic acid group, which is represented by Formula (III), 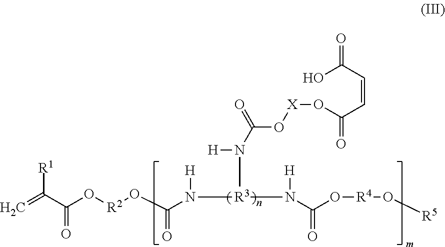
wherein
R¹ is a hydrogen atom or a methyl group;
R² is an alkyl group;
R³ is 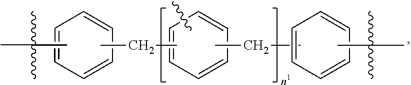
where n¹ is a positive number not lower than 1;
R⁴ is an alkyl group, an alkenyl group, or an alkyl ether group;
R⁵ is 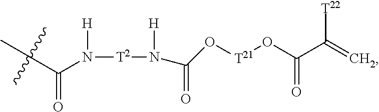
where T² is an organic group, T²¹ is an alkyl group, an alkenyl group, or an alkyl ether group, and T²² is a hydrogen atom or a methyl group; and
X is —CH₂—CH₂—, —CH₂—CH₂—O—CH₂—CH₂—, or 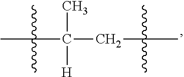 [SMILES: *CC(*)C]
where each of m and n is independently a positive number not lower than 1.

5. The polyurethane (meth)acrylate resin containing the carboxylic acid group as claimed in claim 4, which has an acid value ranging from 10 mgKOH/g to 40 mgKOH/g.

6. A method for preparing a polyurethane (meth)acrylate resin containing a carboxylic acid group, comprising subjecting a hydroxyl group of a monohydric alcohol containing a carboxylic acid group and a hydroxyl group of a (meth)acrylate containing the hydroxyl group to a condensation reaction with multiple isocyanate groups of a polyurethane resin containing multiple isocyanate groups, the monohydric alcohol containing the carboxylic acid group being selected from the group consisting of 2-Butenedioic acid, 1-(2-hydroxyethyl) ester, 2-Butenedioic acid, mono(2-hydroxypropyl) ester, 2-Butenedioic acid, mono[2-(2-hydroxyethoxy)ethyl]ester, and combinations thereof, the (meth)acrylate containing the hydroxyl group being selected from the group consisting of hydroxyethyl acrylate, hydroxyethyl methacrylate, hydroxypropyl acrylate, hydroxypropyl methacrylate, and combinations thereof, the polyurethane resin containing multiple isocyanate groups being represented by Formula (I), 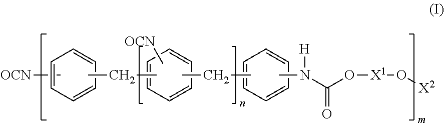
wherein
X¹ is an organic group;
X² is represented by Formula (II); 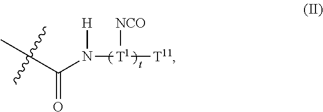
where T¹ is an aromatic group, T¹¹ is a hydrogen atom or an isocyanate group, and each of m, n, and t is independently a positive number not lower than 1, and
wherein
the organic group is an ethyl group, a propyl group, an allyl group, —C₂H₄—O—C₂H₄—, —C₃H₆—O—C₃H₆—, or —C₄H₈—O—C₄H₈—; and
the aromatic group is a phenyl group, 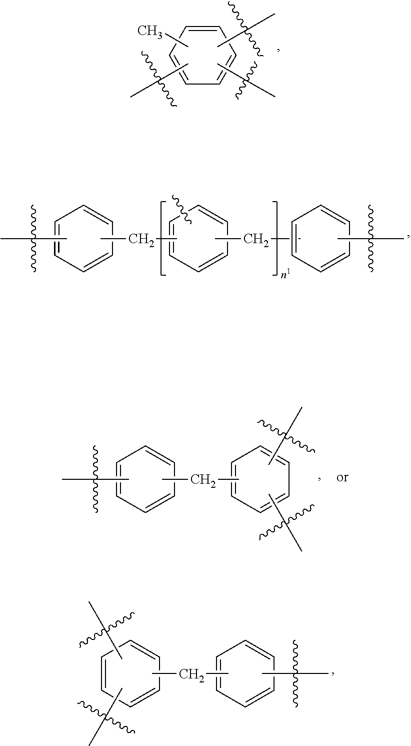
where n¹ is a positive number not lower than 1.

7. The method as claimed in claim 6, further comprising mixing the monohydricalcohol containing the carboxylic acid group with the (meth)acrylate containing the hydroxyl group, so as to obtain a mixture, followed by subjecting the mixture to the condensation reaction with the polyurethane resin containing multiple isocyanate groups.

8. The method as claimed in claim 6, further comprising subjecting the (meth)acrylate containing the hydroxyl group to a first reaction with the polyurethane resin containing multiple isocyanate groups, so as to obtain a reaction mixture, followed by subjecting the monohydric alcohol containing the carboxylic acid group to a second reaction with the reaction mixture.

9. The method as claimed in claim 6, wherein the polyurethane resin containing multiple isocyanate groups is obtained by subjecting a polyol material and a polyisocyanate material to a polycondensation reaction.

10. The method as claimed in claim 6, wherein the monohydric alcohol containing the carboxylic acid group is obtained by subjecting a diol to a reaction with maleic anhydride, the diol being selected from the group consisting of ethylene glycol, diethylene glycol, and glycerol.

11. A curable composition, comprising the polyurethane (meth)acrylate resin containing the carboxylic acid group as claimed in claim 2, and a polymerizable diluent monomer.

12. A curable composition, comprising the polyurethane (meth)acrylate resin containing the carboxylic acid group as claimed in claim 4, and a polymerizable diluent monomer.

13. The curable composition as claimed in claim 11, wherein the polymerizable diluent monomer is selected from the group consisting of methyl acrylate, methyl methacrylate, ethyl acrylate, ethyl methacrylate, hydroxyethyl acrylate, hydroxyethyl methacrylate, hydroxypropyl acrylate, hydroxypropyl methacrylate, isobornyl acrylate, isobornyl methacrylate, cyclohexyl acrylate, cyclohexyl methacrylate, tetrahydrofurfuryl acrylate, tetrahydrofurfuryl methacrylate, styrene, methylstyrene, vinyltoluene, and combinations thereof.

14. The curable composition as claimed in claim 12, wherein the polymerizable diluent monomer is selected from the group consisting of methyl acrylate, methyl methacrylate, ethyl acrylate, ethyl methacrylate, hydroxyethyl acrylate, hydroxyethyl methacrylate, hydroxypropyl acrylate, hydroxypropyl methacrylate, isobornyl acrylate, isobornyl methacrylate, cyclohexyl acrylate, cyclohexyl methacrylate, tetrahydrofurfuryl acrylate, tetrahydrofurfuryl methacrylate, styrene, methylstyrene, vinyltoluene, and combinations thereof.

15. A composite material, comprising a resin component, a fiber material, and a chemical thickener, the resin component being the polyurethane (meth)acrylate resin containing the carboxylic acid group as claimed in claim 2.

16. A composite material, comprising a resin component, a fiber material, and a chemical thickener, the resin component being the curable composition as claimed in claim 11.

17. A composite material, comprising a resin component, a fiber material, and a chemical thickener, the resin component being the curable composition as claimed in claim 12.

18. The composite material as claimed in claim 15, wherein the chemical thickener is selected from the group consisting of an alkaline earth metal oxide, an alkaline earth metal hydroxide, and a combination thereof.

19. The composite material as claimed in claim 16, wherein the chemical thickener is selected from the group consisting of an alkaline earth metal oxide, an alkaline earth metal hydroxide, and a combination thereof.

20. The composite material as claimed in claim 17, wherein the chemical thickener is selected from the group consisting of an alkaline earth metal oxide, an alkaline earth metal hydroxide, and a combination thereof.
